(19) United States
(12) Patent Application Publication
(10) Pub. No.: US 2009/0265667 A1
(43) Pub. Date: Oct. 22, 2009

(54) Techniques for Providing Three-Dimensional Virtual-World Presentations

(76) Inventor: Josef Reisinger, Bornheim (DE)

Correspondence Address: Dillon & Yudell LLP, 8911 N. Capital of Texas Hwy, Suite 2110, Austin, TX, 78759, US

(21) Appl. No.: 12/107,611

(22) Filed: Apr. 22, 2008

(51) Int. Cl. G06F 3/048

(52) U.S. Cl. 715/848

(57) ABSTRACT

A technique for providing a three-dimensional (3D) virtual-world (VW) presentation includes selecting a 3D real-world (RW) presentation. One or more messages, including 3D VW presentation steps that are associated with the 3D RW presentation, are then received at a VW presentation object that includes a VW presentation root script. The one or more messages are passed from the VW presentation root script to VW relay scripts (RSs) included in respective VW presentation objects associated with the 3D VW presentation. The one or more messages are then broadcast from the VW RSs to VW presentation execution scripts (PESs) that are associated with the 3D VW presentation. Finally, the 3D VW presentation is provided based on executed ones of the VW PESs.

### BACKGROUND

1. Field

This disclosure relates generally to virtual-world presentations and, more specifically to techniques for providing three-dimensional virtual-world presentations.

2. Related Art

A web browser (hereinafter “browser”) is a software application that allows a user at a client computer system hereinafter “client”) to display and interact with text, images, and other information located on a web page at a website (hosted by an application server) on the World Wide Web or a local area network. Text and images on a web page may contain hyperlinks to other web pages at the same or different website. Browsers allow a user to quickly and easily access information provided on web pages at various websites by traversing hyperlinks. Browsers usually format hypertext markup language (HTML) information for display and, as such, an appearance of a web page may differ between browsers. A number of different browsers, e.g., Internet Explorer™, Mozilla Firefox™, Safari™, Opera™, and Netscape™, are currently available for personal computers. In general, browsers are the most commonly used type of hypertext transfer protocol (HTTP) user agent. While browsers are typically used to access web application servers (hereinafter “web servers”) that are part of the World Wide Web, browsers can also be used to access information provided by web servers in private networks or content in file systems.

For example, a browser may be utilized by a user to interact with a virtual-world (VW) provided by a VW application server. A VW is a computer-based simulated environment that various users may inhabit and interact with each other via avatars, which are usually depicted as two-dimensional (2D) or three-dimensional (3D) graphical representations. In a typical VW, perceptual stimuli is provided (via a browser) to a user, who can manipulate (via the browser) elements of the VW and, in this manner, experience a virtual presence to some degree. The VW may simulate rules based on the real-world (RW) or some fantasy world. For example, rules associated with gravity, topography, locomotion, real-time actions, and communication may be implemented. Communication between users may range from text, graphical icons, visual gesture, sound, and occasionally forms using touch and balance senses. For example, real-time voice communication using voice over Internet protocol (VOIP) may be implemented. In general, VWs may encompass a wide variety of applications, e.g., games, computer conferencing, and text based chat-rooms.

### SUMMARY

According to one embodiment of present disclosure, a technique for providing a three-dimensional (3D) virtual-world (VW) presentation includes selecting a 3D real-world (RW) presentation. One or more messages, including 3D VW presentation steps that are associated with the 3D RW presentation, are then received at a VW presentation object that includes a VW presentation root script. The one or more messages are passed from the VW presentation root script to VW relay scripts (RSs) included in respective VW presentation objects associated with the 3D VW presentation. The one or more messages are then broadcast from the VW RSs to VW presentation execution scripts (PESs) that are associated with the 3D VW presentation. Finally, the 3D VW presentation is provided based on executed ones of the VW PESs.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example computer network that may be configured to provide a three-dimensional (3D) virtual-world (VW) presentation according to various aspects of the present disclosure.

FIG. 2 is a block diagram of an example script hierarchy for a VW application server configured according to various embodiments of the present disclosure.

FIG. 3 is a signal diagram depicting an example process for providing (displaying) a 3D VW presentation that is initiated through web access according to various aspects of the present disclosure.

FIG. 4 is a flow chart of a process for providing a 3D VW presentation according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer-usable or computer-readable medium may be utilized. The computer-usable or computer-readable medium may be, for example, but is not limited to, an electronic, magnetic, optical, electromagnetic, infrared, or semiconductor system, apparatus, or device. More specific examples (a non-exhaustive list) of the computer-readable medium include: a portable computer diskette, a hard disk, a random access memory (RAM), a read-only memory (ROM), an erasable programmable read-only memory (EPROM) or Flash memory, a portable compact disc read-only memory (CD-ROM), an optical storage device, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide implement the functions/acts specified in the flowchart and/or block diagram block or blocks.

In general, a virtual world (VW), such as Second Life™, attempts to attract companies to create a virtual presence within the VW in order to generate revenue, e.g., advertising revenue. Traditionally, creating a virtual presence within a specific VW has required development of a relatively large amount of intellectual property that is tied to the specific VW. For example, a virtual presence may correspond to a three-dimensional (3D) VW presentation that allows a user to examine items in the 3D VW presentation from various angles, as opposed to traditional two-dimensional presentations provided by tools such as OpenOffice™, Koffice™, MS Office™, etc. The display of items in 3D is particularly useful in technical presentations, where a user may step through, for example, a service oriented architecture (SOA) to see how elements of the SOA interact.

As VWs become more popular, one can assume that a number of VWs, in addition to Second Life™, will become available. One may also assume that various companies, institutions, and/or individuals may wish to maintain a virtual presence in multiple VWs. Unfortunately, using in-world tools (i.e., tools specific to a particular VW) it may be relatively difficult to duplicate presentations in different VWs, as each VW may be implemented in a different incompatible manner. In this case, an individual 3D VW presentation may be required to be created from scratch for each of a number of different VWs.

According to various aspects of the present disclosure, techniques are disclosed that provide 3D VW presentations that are substantially independent of a particular VW. According to various aspects of the present disclosure, a 3D VW presentation is created based on 3D real-world (RW) presentations scripts stored in a 3D presentation (scenario) repository on an RW application server. In this manner, functions associated with a 3D VW presentation may be substantially VW independent in that the functions are substantially created, stored, and executed outside a target VW. Using this approach, functions that are specific to a VW may be substantially reduced to a minimum level. Minimizing VW specific functions is advantageous in that it reduces ownership issues that may be associated with a term of service (TOS) agreement of a particular VW (as in-world elements are reduced to a minimum number of general purpose functions).

According to one aspect of the present disclosure, a technique for providing a three-dimensional (3D) virtual-world (VW) presentation includes selecting a 3D real-world (RW) presentation. One or more messages, including 3D VW presentation steps that are associated with the 3D RW presentation, are then received at a VW presentation object that includes a VW presentation root script. The one or more messages are passed from the VW presentation root script to VW relay scripts (RSs) included in respective VW presentation objects associated with the 3D VW presentation. The one or more messages are then broadcast from the VW RSs to VW presentation execution scripts (PESs) that are associated with the 3D VW presentation. Finally, the 3D VW presentation is provided based on executed ones of the VW PESs.

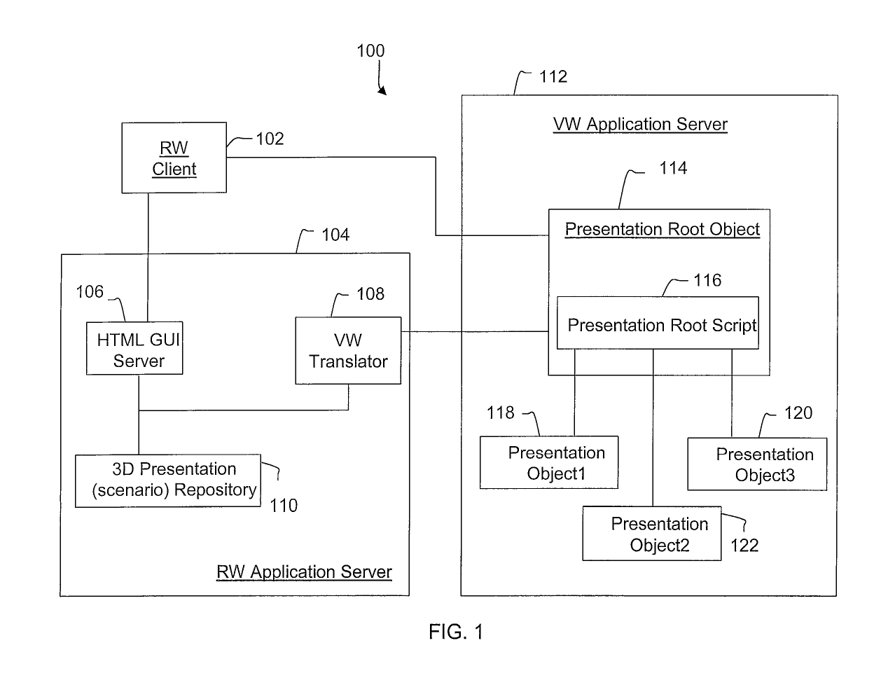

With reference to FIG. 1, a system 100 includes an RW client 102 (which may be, for example, a workstation, a laptop computer system, a notebook computer system, or a desktop computer system that is executing a browser) that is coupled (via, for example, an Internet connection and one or more Internet service providers (ISPs)) to a VW application server 112 and an RW application server 104. A 3D VW presentation may be initiated in-world or via the client 102. An avatar or a user of the client 102 may select from a list of available 3D RW presentations (scenarios) that are defined by 3D RW presentation scripts and metadata that is stored in a 3D RW presentation (scenario) repository 110. In at least one embodiment, a hyper-text mark-up language (HTML) graphical user interface (GUI) server 106 is coupled between the client 102 and the repository 110. A list of presentations for a user of the client 102 may be presented as part of a web page in the HTML-GUI server 106. A VW translator 108 is coupled between the repository 110 and the VW application server 112. The translator 108 facilitates in-world selection by translating the 3D RW presentation scripts and metadata into a format suitable for display in the target VW. In general, the 3D presentation scripts include steps that define how objects in a VW change their properties or perform a function, as well as metadata (e.g., preview, time stamps, author, etc.).

Upon selection of a 3D RW presentation, the translator 108 retrieves associated execution steps and translates the execution steps into low-level steps for a target VW. The translator 108 may translate for a single VW or for multiple VWs. The translator may, for example, create argument lists to be used in application programming interface (API) calls to a Linden scripting language (LSL). In this manner, the translator 108 typically exposes the LSL API to the RW to a maximum possible extent. The 3D RW presentation scripts may be expressed at a relatively high-level to increase independence from particular VWs. In a typical implementation, VW object arrangement is substantially hidden from the 3D RW presentation script to increase re-usability.

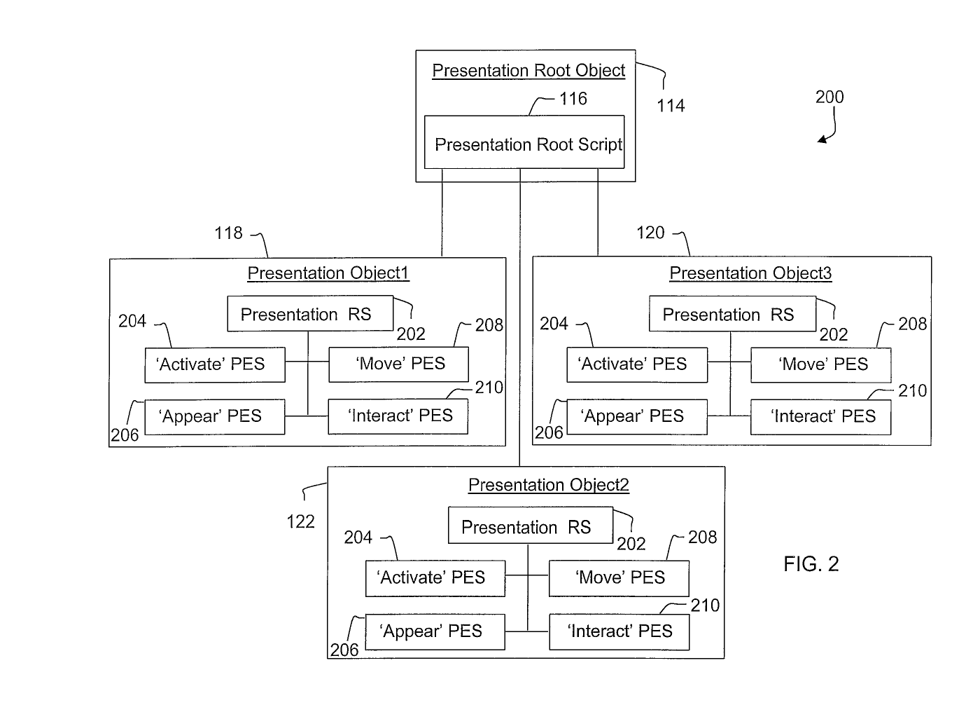

The VW presentation includes objects that visualize associated elements interacting with each other (e.g., an enterprise architecture with SOA elements or a service delivery platform with servlets). In general, a VW object implements logic using, for example, scripts that are configured to interact with other scripts. With reference to FIGS. 1 and 2, a presentation root object 114 includes a presentation root script 116. The presentation root script 116 provides a connection point to the RW. The presentation root script 116 receives (from the translator 108) and validates translated 3D VW presentation step messages. When the 3D presentation step messages are valid, the messages are passed (from the script 116) to presentation relay scripts (RSs) 202 included in objects (in this case objects 118, 120, and 122) that define the 3D VW presentation.

Each of the presentation RSs 202 verify whether a received message is to be executed in its context. If a received message is not for a particular one of the objects 118, 120, and 122, an associated one of the presentation RSs 202 discards the received message. If the received message is directed to an associated one of the objects 118, 120, 122, the RSs 202 simultaneously broadcast the message to associated presentation execution scripts (PESs) 204, 206, 208, and 210. The PESs 204-210, in turn, verify whether their particular capability is requested and, if so, perform an associated action. In this manner, PESs define visual capabilities an associated presentation object provides in a VW. In general, script division increases flexibility and independence between a 3D RW presentation and actual behavior of in-world objects and facilitates addition, alteration, and removal of capabilities at a PES level.

As is illustrated in FIG. 2, each of the objects 118, 120, and 122 include one of the presentation RSs 202 and execute a particular general function that is associated with one of the PESs 204, 206, 208, and 210, which cause an associated object to ‘activate’, ‘appear’, ‘move’, and ‘interact’, respectively. The implementation of the PESs 204-210 define how a step from a 3D RW presentation script is visualized in-world. For example, the ‘appear’ function may be implemented as a gradual change in transparency or as a gradual increase of a size of an associated object to one-hundred percent. How the functions operate are generally left to a designer in a particular VW, without impacting the 3D RW presentation in the repository.

A sample implementation 3D scripting language may be configured according to the following format:

<operation> <object name> <operation arguments . . . >

A presentation scriplet for an IP Multimedia Subsystem (IMS) instance in a Second Life™ island may be configured as follows:

| | |
|---|---|
| “ Activate S-CSCF Start” | ; starts an animation for the S-CSCF |
| “Sleep 8” | ; wait for the avatar to look at it |
| “ Activate HSS Start”, | ; same for HSS |
| “Sleep 5”, | |
| “ Message HSS S-CSCF Start”, | ; animate a message/interaction starting in HSS |
| | going to SCSCF |
| “Sleep 5”, | |
| “ Activate HSS Stop”, | ; stops an animation for the HSS |
| “ Activate S-CSCF Activate Stop” | ; same for S-CSCF |

Distributed script responsibilities allow new objects to be added as needed. A new object may be added by defining a translation rule for a target VW environment and, if needed, adding an appropriate PES for the new feature to the presentation objects in the VW. Various other implementations are possible, especially if the presentations are extracted from existing tools. For example, a rational unified modeling language (UML) model sequence diagram (e.g., that is used to visualize a solution to a customer to train a team of developers) may be transformed into 3D RW presentation scripts.

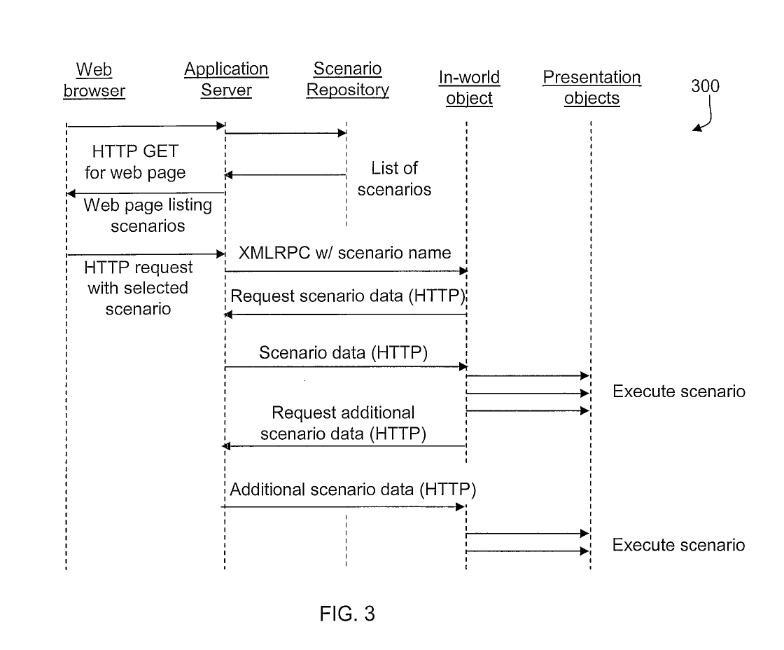

With reference to FIG. 3, a diagram 300 depicts a trigger of a 3D VW presentation through a web access. In general, even if a VW allows RW data to be sent to an in-world object, a volume of data may be too limited, as it is in the case of instantiation in Second Life™. To work around this limitation, signaling from the RW into a VW may be used to trigger a pull of RW data in the VW. In the diagram 300, a request into the VW is used to trigger a pull (by the presentation root object 114) of the presentation data, as the pull of the presentation data from the RW usually facilitates increased data volume. As is illustrated, an HTTP GET is issued from a browser (e.g., executing on the client 102) to an application server (e.g., the HTML GUI server 106) to retrieve a web page that includes a list of presentations (scenarios).

The application server accesses the list of scenarios in a scenario repository (e.g., the 3D RW presentation repository 110) and provides a web page that lists the scenarios. An HTTP request from the web browser provides the selected scenario to the application server, which (in this embodiment) initiates an extensible mark-up language remote procedure call (XML RPC) with the scenario name to the in-world object (e.g., the presentation root object 114). Responsive to the XML RPC, the in-world object requests scenario data using an HTTP transport mechanism. Upon receiving the scenario data via the HTTP transport mechanism, the in-world object passes messages to presentation objects (e.g., the objects 118, 120, and 122) that execute the scenario. The in-world object may then request additional scenario data. Upon receiving the additional scenario data, the in-world object passes the additional scenario data to the presentation objects. The in-world object may continue to pull additional scenario data from the RW in providing the 3D VW presentation.

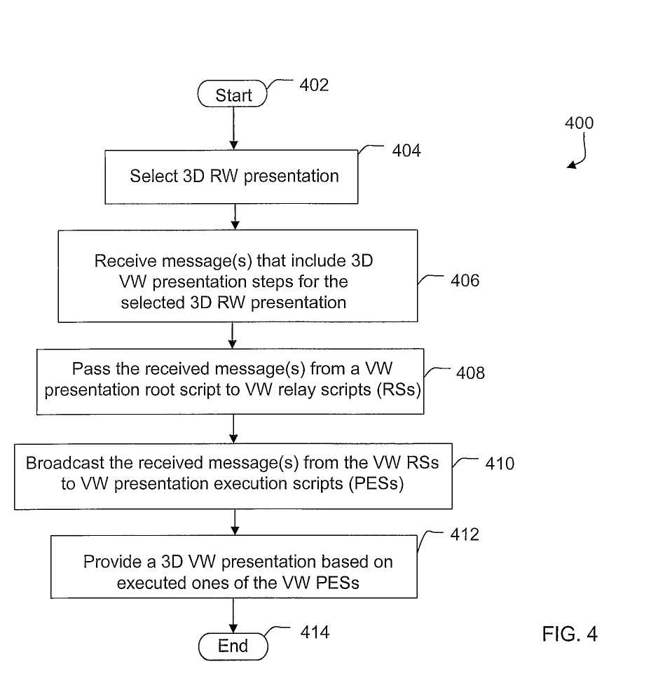

Turning to FIG. 4, a process 400 for providing a 3D VW presentation is initiated in block 402, at which point control transfers to block 404. In block 404, a 3D real-world (RW) presentation is selected (e.g., by a user via a browser or an avatar). Next, in block 406, one or more messages (including 3D VW presentation steps that are associated with the 3D RW presentation) are received at a VW presentation object that includes a VW presentation root script. Then, in block 408, the one or more messages are passed from the VW presentation root script to VW relay scripts (RSs) that are included in respective VW presentation objects associated with the 3D VW presentation. Next, in block 410, the one or more messages are broadcast (passed) from the VW RSs to VW presentation execution scripts (PESs) that are associated with the 3D VW presentation. Finally, in block 412, the 3D VW presentation is provided based on executed ones of the VW PESs. Following block 412, control transfers to block 414 where the process 400 terminates.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

1. A method of providing a three-dimensional virtual-world presentation, comprising:
selecting a three-dimensional real-world presentation whose execution steps are translated into three-dimensional virtual-world presentation steps for a target virtual-world, wherein the three-dimensional real-world presentation is stored in a presentation repository on a real-world application server;
receiving, at a virtual-world presentation object that includes a virtual-world presentation root script, one or more messages including the three-dimensional virtual-world presentation steps that are associated with the three-dimensional real-world presentation;
passing the one or more messages, from the virtual-world presentation root script, to virtual-world relay scripts included in respective virtual-world presentation objects associated with the three-dimensional virtual-world presentation;
broadcasting, from the virtual-world relay scripts, the one or more messages to virtual-world presentation execution scripts associated with the three-dimensional virtual-world presentation; and
providing the three-dimensional virtual-world presentation based on executed ones of the virtual-world presentation execution scripts.
